(19) United States
(12) Patent Application Publication
(10) Pub. No.: US 2005/0220193 A1
(43) Pub. Date: Oct. 6, 2005

(54) Transmission apparatus, reception apparatus and transmission/reception system

(75) Inventor: Gen Ichimura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/084,135

(22) Filed: Mar. 21, 2005

(30) Foreign Application Priority Data
Apr. 2, 2004 (JP) 2004-110257

(51) Int. Cl. H04N 11/04

(52) U.S. Cl. 375/240.26; 386/95

(57) ABSTRACT

The present invention relates to a technique of multiplexing a DSD signal with a video signal according to the clock signal generated on the basis of the attributes of the video signal. The present invention provides a transmission apparatus for transmitting audio data and video data to a reception apparatus, which includes a variable clock generating section generating a clock with a variable frequency as a function of the resolution of the video data, a packetizing section packetizing ΔΣ-modulated 1-bit audio data limited for the sampling frequency and the number of channels according to the resolution of the video data, a multiplexing section multiplexing the ΔΣ-modulated 1-bit audio data packetized by the packetizing section and the video data according to the variable clock generated by the variable clock generating section, and a controller controling the process of generating the variable clock by the variable clock generating section according to the resolution of the video data, that of packetizing the ΔΣ-modulated 1-bit audio data by the packetizing section and that of multiplexing the packetized 1-bit audio data and the video data by the multiplexing section.

### CROSS-REFERENCE TO RELATED APPLICATIONS

The present invention contains subject matter related to Japanese Patent Application JP 2004-110257 filed in the Japanese Patent Office on Apr. 2, 2004, the entire contents of which being incorporated herein by reference.

### BACKGROUND OF THE INVENTION

1. Field of the Invention

This invention relates to a transmission apparatus and a transmission method for performing an operation of delta-sigma (ΔΣ) modulation on a digital input signal of several bits or one bit and transmitting the generated ΔΣ-modulated 1-bit audio data and video data to a reception apparatus. The present invention also relates to a reception apparatus and a reception method for receiving a multiplexed signal of ΔΣ-modulated 1-bit audio data and video data transmitted from a transmission apparatus according to the invention by means of a transmission method also according to the invention and reproducing the received signal. Further, the present invention relates to a transmission/reception system including the transmission apparatus and reception apparatus.

2. Description of Related Art

Linear PCM has been and being used for the data format of digital audio data and for storing such data in recording mediums including CDs and DATs. For example, CDs store each sampled data as 16-bit digital audio data for each channel by means of the PCM system with a sampling frequency fs of about 44.1 kHz. The format to be used for digitally transmitting the digital audio data read out from a CD, a DAT or some other recording medium is defined in IEC60958.

On the other hand, super audio CDs (SA-CDs) adapted to record 1-bit type audio stream data generated by the DSD (direct stream digital) system with a very high sampling frequency (e.g., a frequency that is sixty four times higher than the sampling frequency fs of ordinary CDs) has been known. A 1-bit audio digital signal is obtained by performing an operation of over-sampling ΔΣ modulation with a frequency of 64 fs on an input signal. The 1-bit signal is decimated to a multi-bit PCM code immediately thereafter for CD-type audio system, whereas the 1-bit audio signal generated by ΔΣ modulation (ΔΣ-modulated 1-bit audio data) is directly recorded on an SA-CD using the DSD system. The frequency band of the ΔΣ-modulated 1-bit audio data stored on SA-CDs is about 100 kHz, which is much wider than the frequency band of the signals of the PCM system stored on CDs. IEEE1394 (IEC61883) is applied to digital audio transmission of ΔΣ-modulated 1-bit audio data. The applicant of the present patent application has disclosed techniques for 1-bit audio data transmission using a bus line conforming to IEEE1394 in Japanese Patent Application Laid-Open Publication No. 2001-223588 and Japanese Patent Application Laid-Open Publication No. 2002-217911.

Meanwhile, in recent years, a high-definition multimedia interface (HDMI) that can digitally simultaneously transmit a base-band high definition television signal and a multi-channel audio signal of the linear PCM audio system has been devised. Details of the HDMI are disclosed in the Internet home page having the address of http://www.licensing.philips.com.

### SUMMARY OF THE INVENTION

However, no technique has been established to digitally simultaneously transmit a multi-channel audio signal of ΔΣ-modulated 1-bit audio data and a base-band high definition television signal.

In view of the above-identified circumstances, it is desirable to provide a transmission apparatus and a transmission method for digitally simultaneously transmitting a multi-channel audio signal of ΔΣ-modulated 1-bit audio data and base band video data.

It is also desirable to provide a reception apparatus and a reception method for receiving and reproducing a multiplexed signal of ΔΣ-modulated 1-bit audio data and video data transmitted from a transmission apparatus by means of a transmission method as cited above.

It is also desirable to provide a transmission/reception system for transmitting and receiving digitally simultaneously a multi-channel audio signal of ΔΣ-modulated 1-bit audio data and base band video data.

According to the present invention, the above objects are achieved by providing a transmission apparatus for transmitting audio data and video data to a reception apparatus, the apparatus comprising: a variable clock generating means for generating a clock with a variable frequency as a function of the resolution of the video data; a packetizing means for packetizing ΔΣ-modulated 1-bit audio data limited for the sampling frequency and the number of channels according to the resolution of the video data; a multiplexing means for multiplexing the ΔΣ-modulated 1-bit audio data packetized by the packetizing means and the video data according to the variable clock generated by the variable clock generating means; and a control means for controlling the process of generating the variable clock by the variable clock generating means according to the resolution of the video data, that of packetizing the ΔΣ-modulated 1-bit audio data by the packetizing means and that of multiplexing the packetized 1-bit audio data and the video data by the multiplexing means.

Thus, in a transmission apparatus according to the invention, the control means controls the process of generating a variable clock by the variable clock generating means according to the resolution of the video data, that of packetizing the ΔΣ-modulated 1-bit audio data by the packetizing means and that of multiplexing the packetized 1-bit audio data and the video data by the multiplexing means so that it is possible to digitally simultaneously transmit a multi-channel audio signal of ΔΣ-modulated 1-bit audio data and base band video data.

According to the present invention, there is provided a reception apparatus for receiving a multiplexed signal of video data and packetized and ΔΣ-modulated 1-bit audio data limited for the sampling frequency and the number of channels according to the resolution of the video data, the reception apparatus comprising: a separating means for separating the video data and the packetized audio data from the multiplexed signal; a depacketizing means for depacketizing the packetized audio data separated by the separation means; and an audio output means for outputting the 1-bit audio data depacketized by the depacketizing means.

Thus, in a reception apparatus according to the invention, the separating means separates the video data and the packetized audio data of the multiplexed signal of the video data and the packetized ΔΣ-modulated 1-bit audio data limited for the sampling frequency and the number of channels according to the resolution of the video data, the depacketizing means depacketizes the packetized audio data separated by the separation means and subsequently the audio output means outputs the 1-bit audio data depacketized by the depacketizing means so that it is possible to receive and reproduce the multiplexed signal of the ΔΣ-modulated 1-bit audio data and the video data transmitted from a transmission apparatus according to the invention.

According to the present invention, there is provided a transmission/reception system comprising: a transmission apparatus for transmitting audio data and video data to a reception apparatus, the apparatus including: a variable clock generating means for generating a clock with a variable frequency as a function of the resolution of the video data; a packetizing means for packetizing ΔΣ-modulated 1-bit audio data limited for the sampling frequency and the number of channels according to the resolution of the video data; a multiplexing means for multiplexing the ΔΣ-modulated 1-bit audio data packetized by the packetizing means and the video data according to the variable clock generated by the variable clock generating means; and a control means for controlling the process of generating the variable clock by the variable clock generating means according to the resolution of the video data, that of packetizing the ΔΣ-modulated 1-bit audio data by the packetizing means and that of multiplexing the packetized 1-bit audio data and the video data by the multiplexing means; and a reception apparatus including: a separating means for separating the video data and the packetized audio data of the multiplexed signal of the video data and the packetized ΔΣ-modulated 1-bit audio data limited for the sampling frequency and the number of channels according to the resolution of the video data; a depacketizing means for depacketizing the packetized audio data separated by the separation means; and an audio output means for outputting the 1-bit audio data depacketized by the depacketizing means.

Thus, a transmission/reception system according to the invention can digitally simultaneously transmit and receive a multi-channel audio signal of ΔΣ-modulated 1-bit audio data and base-band video data.

### BRIEF DESCRIPTION OF THE DRAWINGS

FIG. 1 is a schematic block diagram of an embodiment of video/audio data transmission/reception system according to the invention;

FIG. 2 is a schematic block diagram of a disc replay apparatus;

FIG. 3 is a schematic block diagram of a 1-bit ΔΣ-modulator;

FIG. 4 is a schematic block diagram of a transmission apparatus according to the invention;

FIG. 5 is a chart of specifications for transmission of PCM audio data including the sampling frequencies and the number of channels for images of various types with vertical synchronizing frequencies of 60 Hz and 50 Hz;

FIG. 6 is a schematic illustration of transmission of PCM audio data;

FIG. 7 is a chart of headers for audio sample packets of linear PCM data;

FIG. 8 is a chart of data for audio sample packets of linear PCM data;

FIG. 9 is a chart for 2-channel transmission with a sampling frequency of not higher than fs96 kHz and 8-channel transmission with a sampling frequency of not higher than fs48 kHz for 480 p/576 p of linear PCM;

FIG. 10 is a chart for 8-channel transmission with a sampling frequency of fs96 kHz for a double pixel arrangement of 480 p/576 p;

FIG. 11 is a schematic illustration of the relationship of headers, sample packets and sub-packets;

FIG. 12 is a schematic illustration of DSD data buried in the part of data of 24 bits that are used for linear PCM;

FIG. 13 is a schematic illustration of DSD 8-CH;

FIG. 14 is a schematic illustration of video modes that cannot be used for multi-channel transmission because of limitations posed by the video resolution;

FIG. 15 is a schematic illustration of packetized formats of DSD 6-CH;

FIG. 16 is a schematic illustration of DSD 6-CH;

FIG. 17 is a schematic illustration of video modes that are made usable for multi-channel transmission; and

FIG. 18 is a schematic block diagram of a reception apparatus.

### DETAILED DESCRIPTION OF THE PREFERRED EMBODIMENT

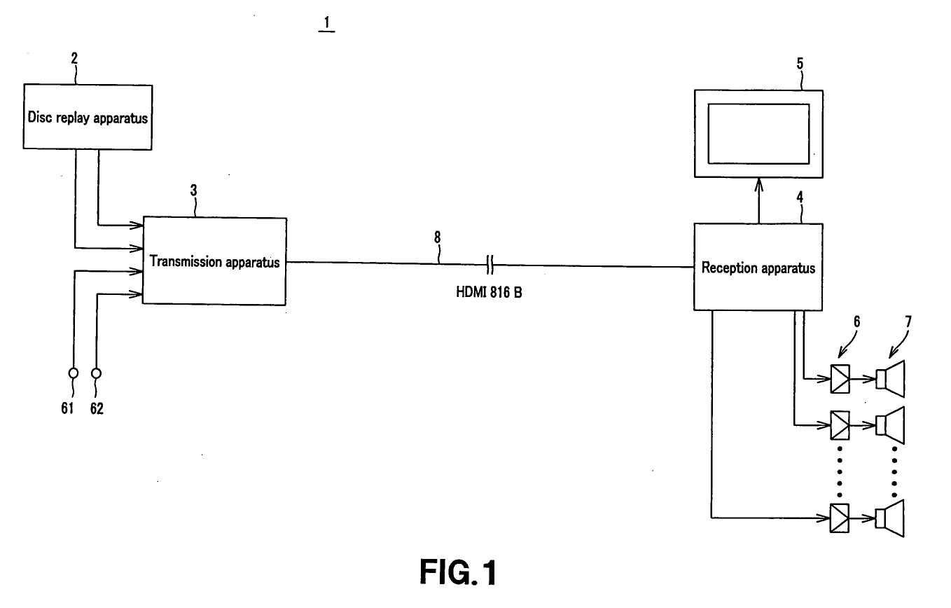

Now, the present invention will be described in greater detail by referring to the accompanying drawings that illustrate preferred embodiments of the invention. FIG. 1 is a schematic block diagram of an embodiment of video/audio data transmission/reception system 1 according to the invention. The video/audio data transmission/reception system 1 comprises a transmission apparatus 3 adapted to multiplex the video data reproduced by disc replay apparatus 2 and ΔΣ-modulated 1-bit audio data and transmit the multiplexed video/audio data, a reception apparatus 4 for receiving the multiplexed video/audio data transmitted from the transmission apparatus 3. The reception apparatus 4 divides the multiplexed video/audio data and causes a monitor/receiving set 5 to display the images of the video signal reproduced according to the separated video data and multi-channel speakers 7 to output the audio signal reproduced according to the separated 1-bit audio data. A cable 8 designed for a high definition multimedia interface (HDMI) conforming to the HDMI816B Standard is used as communication path.

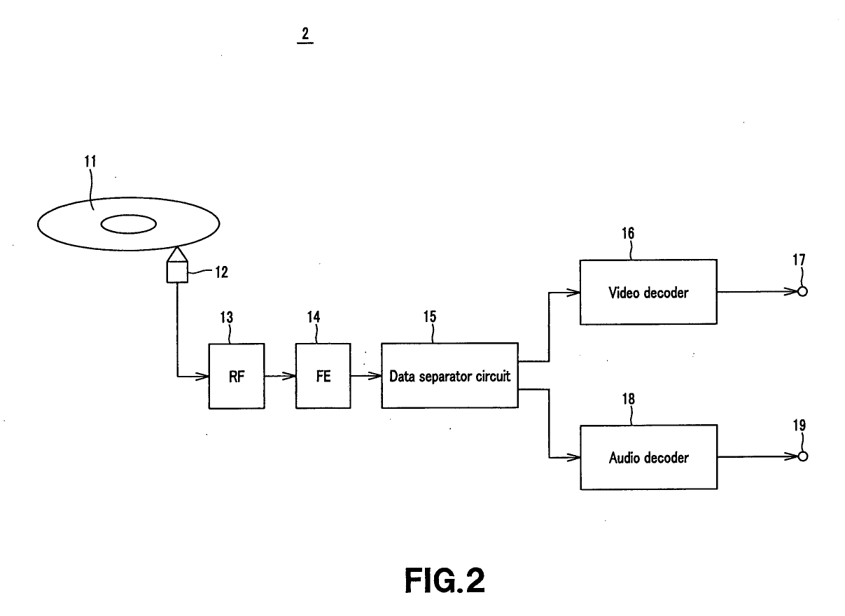

FIG. 2 is a schematic block diagram of the disc replay apparatus. Disc 11 stores video data conforming to the NPEG (Moving Picture Coding Experts Group) Standard. The disc 11 also stores 1-bit audio data of the direct stream digital (DSD) system, which will be described in greater detail hereinafter, and multiplexed with the video data. In the case of a movie, an opera, a theatrical play or a musical, the video data and the 1-bit audio data are correlated data. The disc 11 may store video data that are related to an album conforming to the SA-CD Standard and containing 1-bit audio data of the DSD system. Alternatively, the disc 11 may store the video data of the still image of the album jacket conforming to the JPEG Standard.

Optical pickup 12 includes a laser beam source, a beam splitter, an objective lens, a light receiving element (photodiode). The optical pickup 12 irradiates a laser beam onto the disc 11 and receives the reflected light of the laser beam coming from the disc 11. Then, it converts the received light into an electric signal and supplies it to RF circuit 13. The reflected light from the disc 11 changes according to the data stored on the disc 11.

The RF circuit 13 produces a reproduction RF signal from the signal coming from the optical pickup 12 and carries out various processes including a waveform equalization process and a binarization process on it to produce reproduction data, which is supplied to front end circuit 14 (to be referred to FE circuit hereinafter). The RF circuit 13 also produces servo error signals including a tracking error signal and a focus error signal.

Thus, the optical pickup 12 can scan the tracks of the disc 11 that store data with a laser beam showing a spot of light of an appropriate size, performing various control operations including tracking error control, focus error control and so on by using the servo error signals.

While the disc replay apparatus 2 includes a spindle motor for driving the disc 11 to rotate, a sled mechanism for driving the optical pickup in a radial direction and a biaxial actuator for finely adjusting the position of the optical pickup in a direction perpendicular to the disc and a radial direction of the disc, they are omitted from FIG. 2 for the purpose of simplification.

The FE circuit 14 performs various processing operations on the supplied reproduction data including demodulation and error correction and supplies the processed reproduction data to data separation circuit 15. The data separation circuit 15 divides the reproduction data into the video data and the 1-bit audio data that are multiplexed and stored on the disc 11 and separate them from each other. The video data obtained from the reproduction data by the data separation circuit 15 are supplied to video decoder 16. On the other hand, the 1-bit audio data obtained from the reproduction data by the data separation circuit 15 are supplied to audio decoder 18. The video decoder 16 temporarily stores the video data in a video code buffer (not shown) and then takes out the video data for a decoding process. Then, it transmits the decoded and expanded video data to the multiplexing circuit of the transmission apparatus 3 from output terminal 17. On the other hand, the audio decoder 18 temporarily stores the audio data in an audio code buffer (not shown) and then takes out the audio data for a decoding process. Then, it transmits the decoded and expanded audio data to the packetizing circuit of the transmission apparatus 3 by way of output terminal 19.

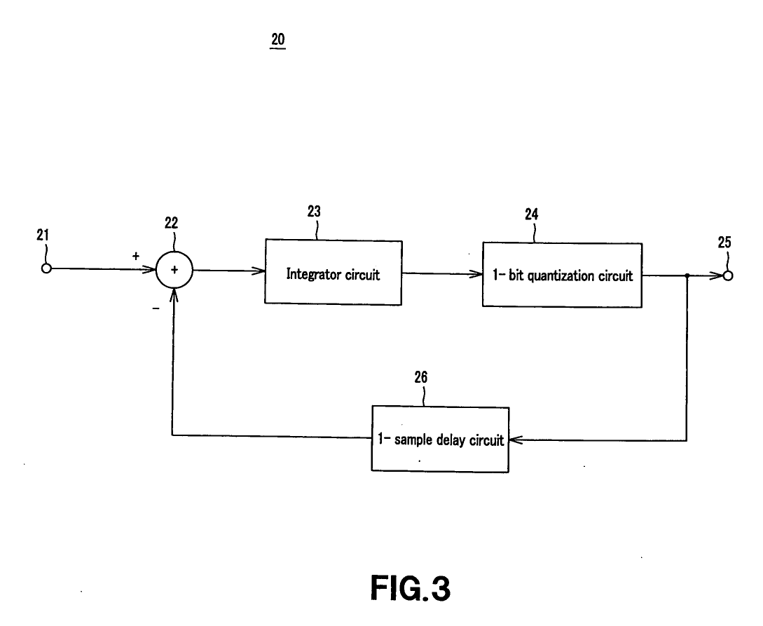

FIG. 3 is a schematic block diagram of the 1-bit ΔΣ-modulator 20 for generating 1-bit audio data of the DSD system to be recorded on a disc. The ΔΣ-modulator 20 comprises an adder circuit 22, an integrator circuit 23, a 1-bit quantization circuit 24, a 1-sample delay circuit 26. The addition output of the adder circuit 22 is supplied to the integrator circuit 23 and the integration output of the integrator circuit 23 is supplied to the 1-bit quantization circuit 24. The quantization output of the 1-bit quantization circuit 24 is led out from output terminal 25. At the same time, it is prefixed with a negative sign and fed back to the adder circuit 22 by way of the 1-sample delay circuit 26 so as to be added to the analog audio signal supplied from input terminal 21. The addition output of the adder circuit 22 is integrated by the integrator circuit 23. Since the integration output of the integrator circuit 23 is quantized by the 1-bit quantization circuit 24 for every 1-sample period, it is now possible to output 1-bit quantized data, or 1-bit audio data from the output terminal 25.

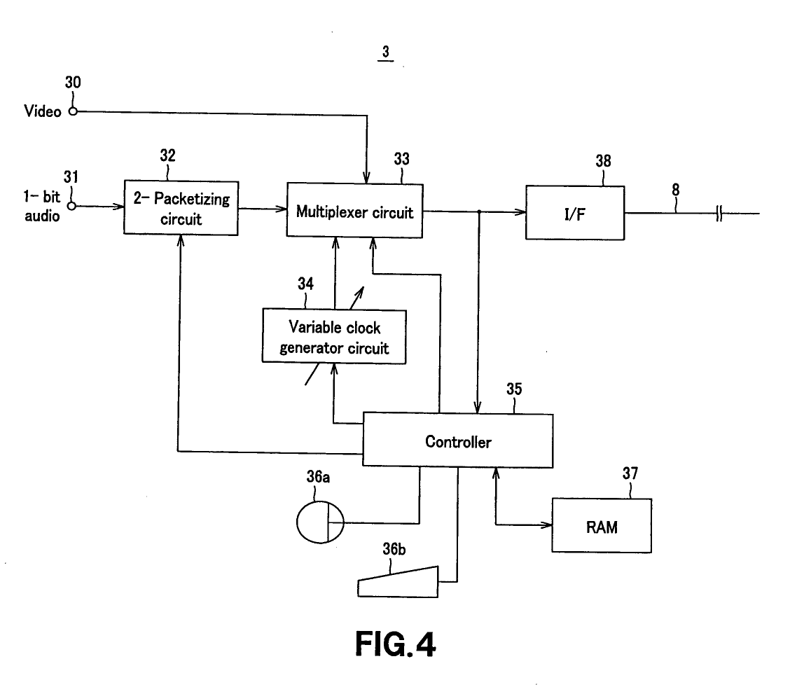

FIG. 4 is a schematic block diagram of the transmission apparatus 3. The transmission apparatus 3 comprises a variable clock generator circuit 34 for generating a variable clock whose frequency changes according to the resolution of video data, a packetizing circuit 32 for packetizing ΔΣ-modulated 1-bit audio data limited for the sampling frequency and the number of channels according to the resolution of the video data, a multiplexer circuit 33 for multiplexing the ΔΣ-modulated 1-bit audio data packetized by the packetizing circuit 32 and the video data and an I/F circuit 38 for transmitting the multiplexed data generated by the multiplexer circuit 33 to the cable 8. The transmission apparatus 3 also comprises a controller 35 for controlling the variable clock generating process of the variable clock generator circuit 34, the packetizing process of the packetizing circuit 32 for packetizing 1-bit audio data and the multiplexing process of the multiplexer circuit 33. An input operation unit 36 including a mouse 36a and a keyboard 36b is connected to the controller 35. A memory section (RAM) 37 for storing the characteristics of the monitor/receiving set 5, which is connected to the reception apparatus 4, is also connected to the controller 35.

The variable clock generator circuit 34 generates a variable clock whose frequency changes according to the resolution of the video data to be transmitted to the reception apparatus 4. The resolution of the video data to be transmitted is defined by the resolution potential of the monitor/receiving set 5 of the reception apparatus 4.

The multiplexer circuit 33 multiplexes the video data for which a clock is generated with a variable frequency by the variable clock generator circuit 34 and the packetized 1-bit audio data. The process of multiplexing video data and 1-bit audio data of the multiplexer circuit 33 varies depending on the resolution of the video data to be transmitted or the resolution of the monitor/receiving set 5 of the reception apparatus 4.

This is because the video/audio data transmission/reception system uses a cable 8 conforming to the HDMI816B Standard that is applicable to high definition multimedia interfaces (HDMIs). The bandwidth that can be used for data transmission by the system is limited. In other words, it is not limitless. However, the bandwidth for data transmission that involves the use of a cable 8 conforming to the HDMI816B Standard is variable and determined as a function of the size of the video data. For example, it is possible to transmit a large volume of data if the bandwidth is for high definition images. However, the volume of data that can be transmitted per unit time is limited if the bandwidth is for a VGA (video graphics array) of ordinary 640×480 pixels when compared with the bandwidth for high definition images. This is because, when video data are transmitted, a pixel clock is also transmitted for scanning. The pixel clock changes as a function of the image size or the resolution. In other words, a clock of a high frequency is transmitted for high definition images whereas a clock of a low frequency is transmitted for VGA images.

With an HDMI, audio data are transmitted by utilizing gaps of transmissions of video data. More specifically, they are transmitted by utilizing each blanking period. Since the blanking period for transmitting video data of images to be displayed with a small number of pixels is inevitably shorter than the blanking period for transmitting video data to be displayed with a large number of pixels, the transmission rate of audio data is relatively low.

Thus, for transmission of video data and audio data by means of an HDMI, a pixel clock is transmitted along with the data. As a result, the sampling frequency and the number of channels of the digital audio data to be transmitted are limited as a function of the format (resolution) of the images to be transmitted with the digital audio data.

For this reason, the transmission apparatus 3 requests transmission of information on the resolution of the monitor/receiving set 5 of the reception apparatus 4 and writes the information on the resolution transmitted in response to the request in the RAM 37. Then, the controller 35 reads the information on the resolution from the RAM 37 and causes the variable clock generator circuit 34 to generate a clock according to the resolution and the multiplexer circuit 33 to multiplex the video data and the packetized audio data in synchronism with the clock.

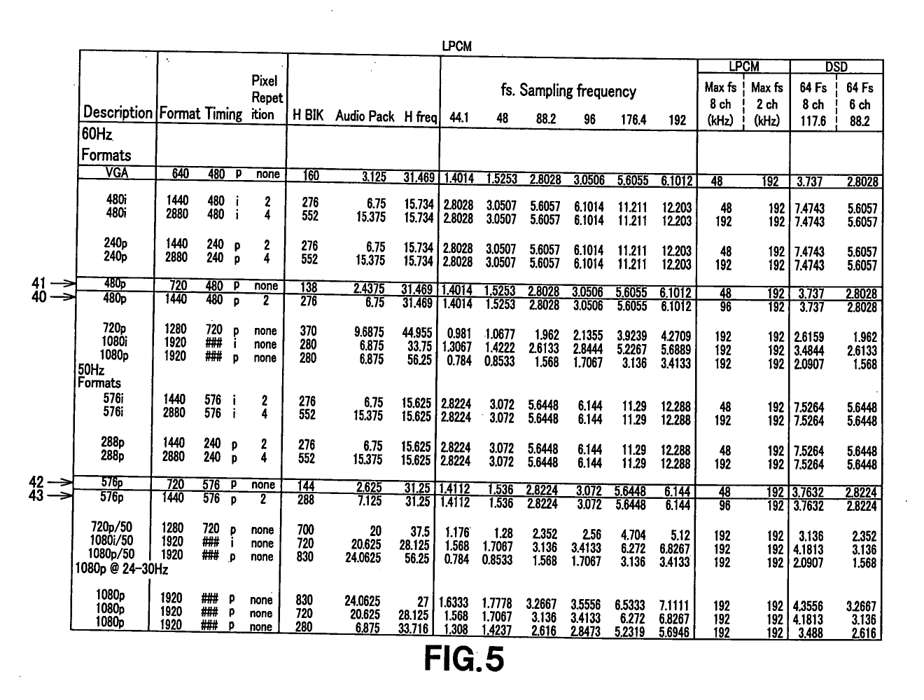

FIG. 5 is a chart of specifications for transmission of PCM audio data including the sampling frequencies and the number of channels for images of various types with vertical synchronizing frequencies of 60 Hz and 50 Hz. For example, arrow 40 points the image type of 480 p, the format timing of 1440×480 p and the vertical synchronizing frequency of 59.94 Hz [1440×480 P@59.94 Hz]. Basically, these figures are determined as a function of the audio packs that can be transmitted in a horizontal blanking (H-Blk) period.

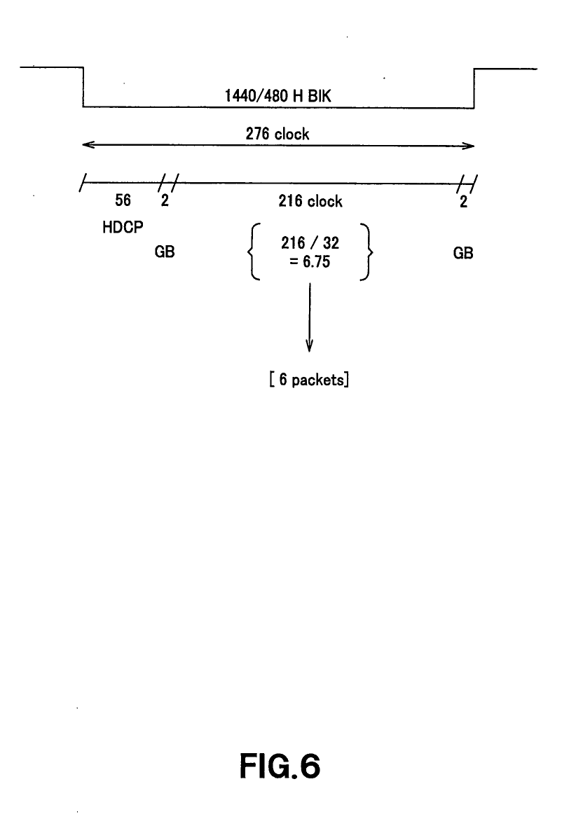

As shown in FIG. 6, the number of clocks for the horizontal blanking (H-Blk) is 276. However, 56 clocks are required for the key generation process for high-bandwidth digital content protection (HDCP) and 2 clocks*2 are required for the front and rear guard bands GB. Thus, the number of clocks that can be specified for actual data transmission is 276−56−(2*2)=216 clocks. Since the number of clocks required for transmitting an audio sample packet is 32, the number of audio sample packets that can be transmitted is 216/32=6.75, which is rounded down to 6. Thus, it is possible to maximally transmit six packets.

In the case of multi-channel PCM (equal for 3 through 8 channels), the horizontal synchronizing frequency (H freq) is 31.469 kHz for this video format. Therefore, if the sampling frequency fs is 96 kHz, 96/31.469=3.0506 . . . packets, which is rounded up to 4 packets, have to be transmitted per 1 H in average. Thus, it is necessary to transmit four packets per 1 H. Since it is possible to maximally transmit six packets as pointed out above, the sampling frequency can be used (OK) for multi-channel PCM. If the sampling frequency fs is 192 kH,z 192/31.469=6.1012 . . . packets, which is rounded up to 7 packets, have to be transmitted per 1 H in average. Because it exceeds six, the sampling frequency cannot be used (NG) for multi-channel PCM.

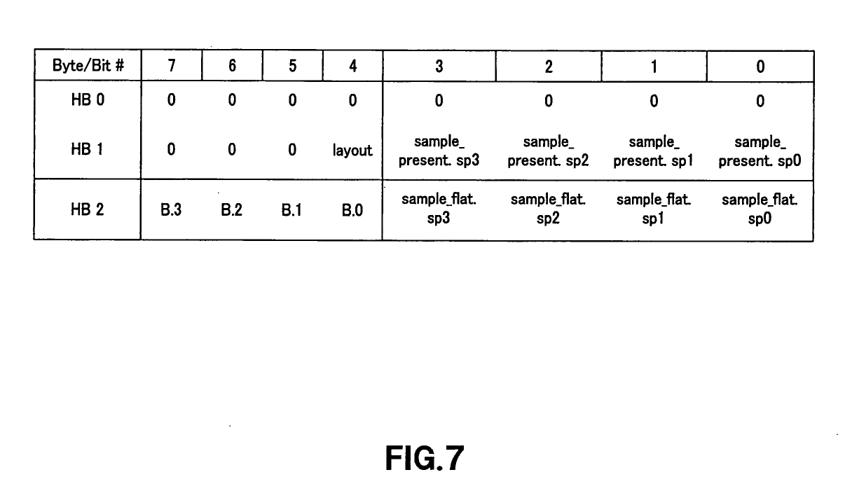

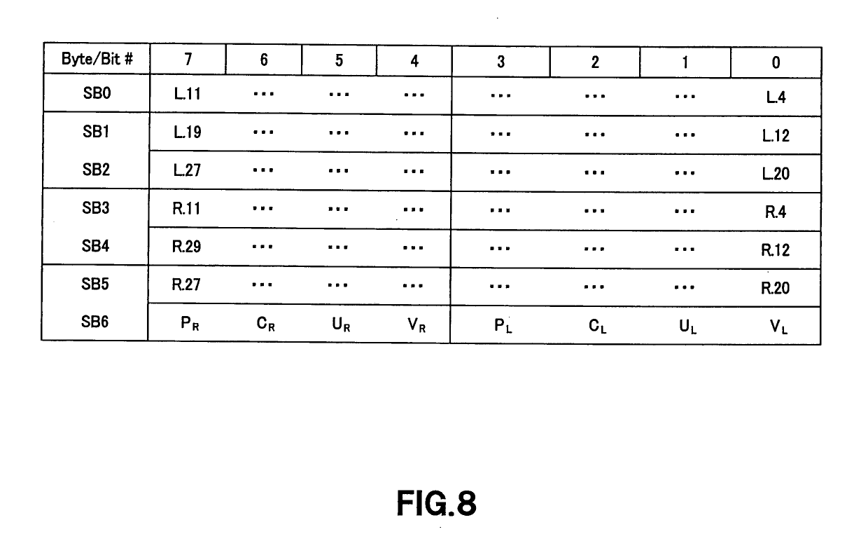

Linear PCM data use audio sample packets on the basis of the IEC60958 Standard and are transmitted with a header and a data format as shown in FIG. 7 and FIG. 8 respectively. As shown in FIG. 7, the header has 3 bytes of three layers HB0, HB1, HB2, each being of 1 byte. Audio sample sub-packets are assigned to two layers including 0 through 3 bits of HB1 and 0 through 3 bits of HB2. Sample presents spX (sample_present_sp0, 1, 2 and 3) are assigned to 0 through 3 bits of HB1. They indicate that they are sub-packets containing audio samples. Sample flats spX (sample_flat_sp0, 1, 2, 3) are assigned to 0 through 3 bits of HB2. They indicate that they are flat line samples. They become effective when sample presents spX are set. B.X (B.0 through B.3) are assigned to 4 through 7 bits of HB2. When “1”, it indicates that they are contained in the first frame of IEC60958block. When “0”, on the other hand, it indicates that they are contained in another frame.

As shown in FIG. 8, data are broken down into seven layers SB0, SB1, . . . , SB6, each having 1 byte. The bit codes from time slot X of the left channel (first sub-frame) are assigned to SB0 through SB2 as L.4 through L.11, L.12 through L.19 and L.20 through L.27 respectively. The bit codes from time slot X of the right channel (second sub-frame) are assigned to SB3 through SB5 as R.4 through R.11, R.12 through R.19 and R.20 through R.27 respectively. The effective bit, the user data bit, the channel status bit and the even parity bit of the first sub-frame (left channel) are assigned to 0 through 3 bits of SB6 as V_{L}, U_{L}, C_{L}, P_{L} respectively. Similarly, the effective bit, the user data bit, the channel status bit and the even parity bit of the second sub-frame (right channel) are assigned to 4 through 7 bits of SB6 as V_{R}, U_{R}, C_{R}, P_{R} respectively.

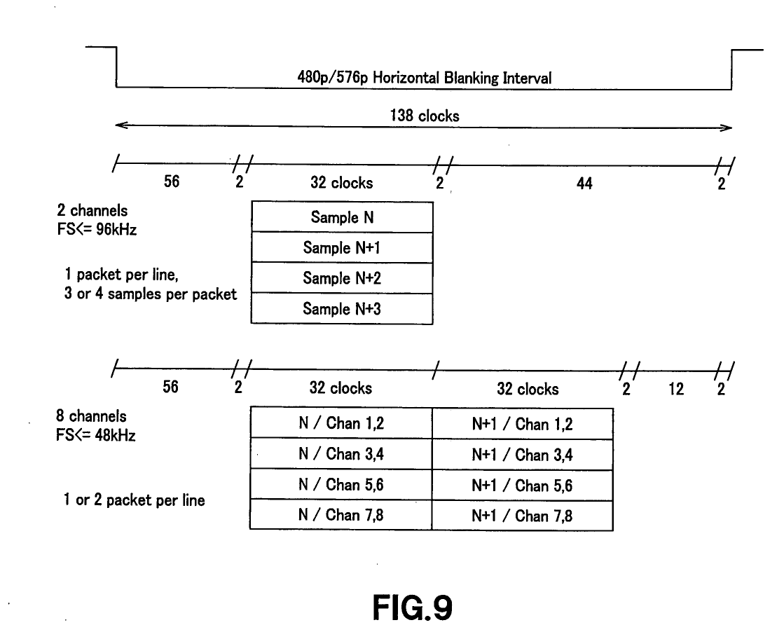

Multi-channel transmission of liner PCM can be realized by combining a plurality of packets of the above described type. FIG. 9 shows a specific example of transmission through two channels with a sampling frequency of not higher than fs96 kHz and transmission through eight channels with a sampling frequency of not higher than fs48 kHz.

2-channel transmission is conducted by using horizontal blanking H-Blk 138 clocks in a manner as described below. 56 clocks are used for a key generation process of high bandwidth digital content protection (HDCP) and then 2 clocks are used for a guard band GB. Immediately after the guard band GB, 32 clocks are assigned to samples N, N+1, N+2, N+3. 1 packet is assigned to a horizontal line and 3 or 4 samples are assigned per packet.

8-channel transmission is conducted also by using horizontal blanking H-Blk 138 clocks in a manner as described below. 56 clocks are used for a key generation process of HDCP and then 2 clocks are used for a guard band GB. Immediately after the guard band GB, 32 clocks are assigned to channels 1 and 2, 3 and 4, 5 and 6 and 7 and 8 of sample N. Immediately thereafter, 32 clocks are assigned to channels 1 and 2, 3 and 4, 5 and 6 and 7 and 8 of sample N+1. 1 or 2 packets are assigned to a line.

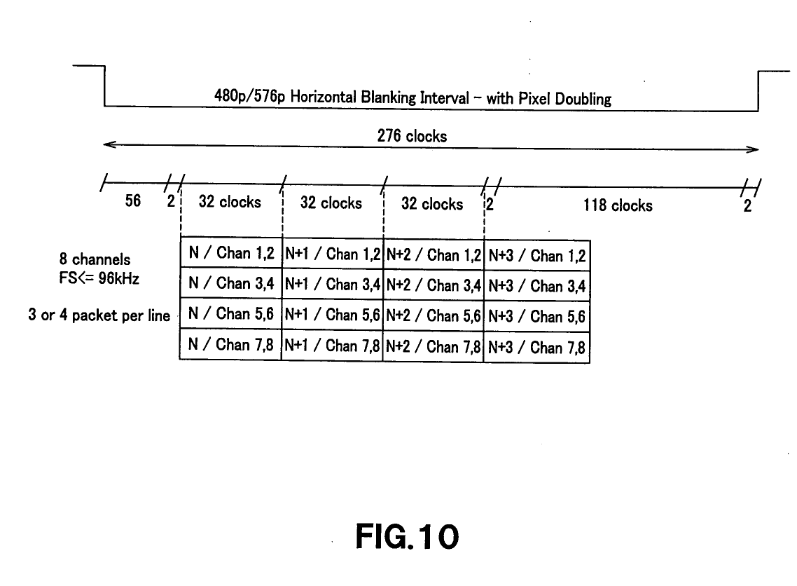

FIG. 10 shows a specific example of transmission through eight channels with a sampling frequency of fs96 kHz for a double pixel arrangement of 480 p/576 p (as pointed by arrows 40 and 43 in FIG. 5). Because of the double pixel arrangement, horizontal blanking H-Blk 276 clocks are used in a manner as described below. 56 clocks are used for a key generation process of HDCP and then 2 clocks are used for a guard band GB. Immediately after the guard band GB, 32 clocks are assigned to channels 1 and 2, 3 and 4, 5 and 6 and 7 and 8 of sample N. Immediately thereafter, 32 clocks are assigned to channels 1 and 2, 3 and 4, 5 and 6 and 7 and 8 of sample N+1. Subsequently, 32 clocks are assigned to channels 1 and 2, 3 and 4, 5 and 6 and 7 and 8 of sample N+2. After 2 clocks used for a guard band GB, 32 clocks may be assigned to channels 1 and 2, 3 and 4, 5 and 6 and 7 and 8 of sample N+3 thereafter. 3 or 4 packets are assigned to a line.

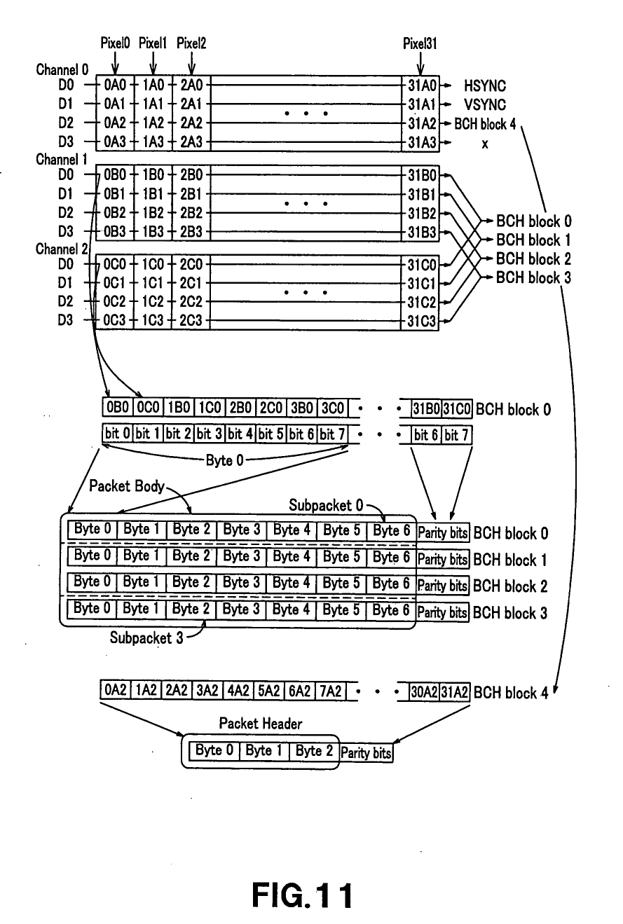

Each sample packet is constituted by sub-packets (with a unit of 7 bytes). FIG. 11 illustrates the relationship of headers, sample packets and sub-packets. Channel 0, channel 1 and channel 2 are listed as sample packets. Channel 0 is used for 0Ai through 31Ai of D0 through D3 in synchronism with pixel clock 0, pixel clock 1, . . . , pixel clock 31 where i represents the numerals of D0 through D3. D0 is used for horizontal synchronization HSYNC and D1 is used for vertical synchronization VSYNC. D2 is used for BCHblock4. Similarly, each of channels 1 and 2 is used for 0Ai through 31Ai of D0 through D3 in synchronism with pixel clock 0, pixel clock 1, . . . , pixel clock 31. D0 of channel 1 and D0 of channel 2 constitute BCHblock0. D1 of channel 1 and D1 of channel 2 constitute BCHblock1. Likewise, Di of channel 1 and Di of channel 2 is used for BCHblocki.

BCHblock0 is constituted by 0B0 of channel 1, 0C0 of channel 2, 1B0 of channel 1, 1C0 of channel 2 followed by mB0 of channel 1 and mC0 of channel 2, where m represents the numbers 0 through 31 of pixel clocks. BCHblock1 is constituted by 0B1 of channel 1, 0C1 of channel 2, 1B1 of channel 1, 1C1 of channel 2 followed by mB1 of channel 1 and mC1 of channel 2. Similarly, BCHblocki is constituted by mBi of channel 1 and mCi of channel 2. Groups of eight bits are produced from the data of each of the CHblock0 through 3 to form sub-packets 0 through 3 of Byte0 through Byte6. The sub-packets 0 through 3 constitute a packet body. Two parity bits are added to each sub-packet. Groups starting from 0A1 are produced from BCHblock4 to form packet headers of 3Byte0 through 2. A parity bit is added to each packet header. In this way, an audio packet is formed by using data for two channels for linear PCM. Thus, four audio packets are formed and used for 8-channel transmission. Data transmission by linear PCM proceeds in the above described manner.

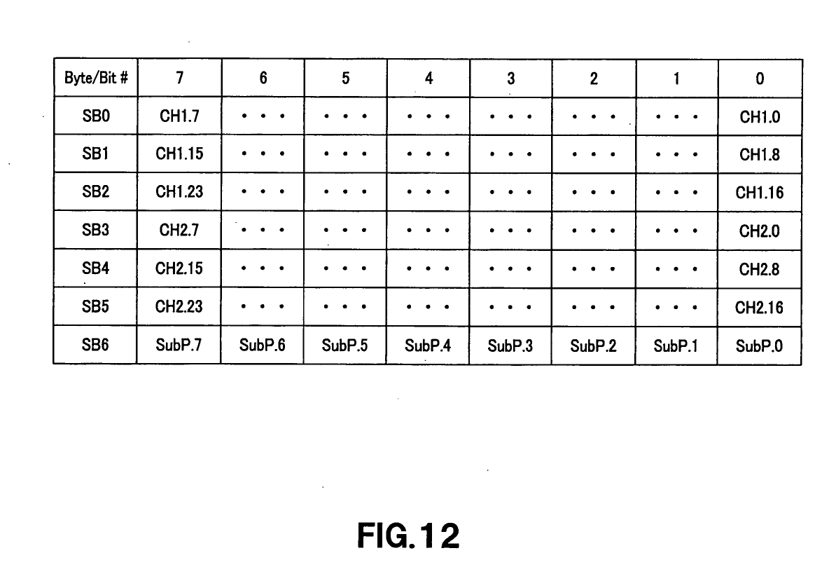

As for definition of transmission by the DSD system, it may be conceivable to bury DSD data in the part of the data of 24 bits that have been used for linear PCM and subordinate data are used to newly define the added new DSD packets as shown in FIG. 12. This is a simple way. More specifically, referring to FIG. 12, 24 bits (CH1.0˜CH1.24) of the DSD data of the first (left) channel are packetized for SB0 through SB2 as CH1.X. Similarly, 24 bits (CH2.0˜CH2.24) of the DSD data of the second (right) channel are packetized for SB3 through SB5. SubP.X (0 through 7) are assigned to SB6. This is also a way for forming an audio packet by using data for two channels.

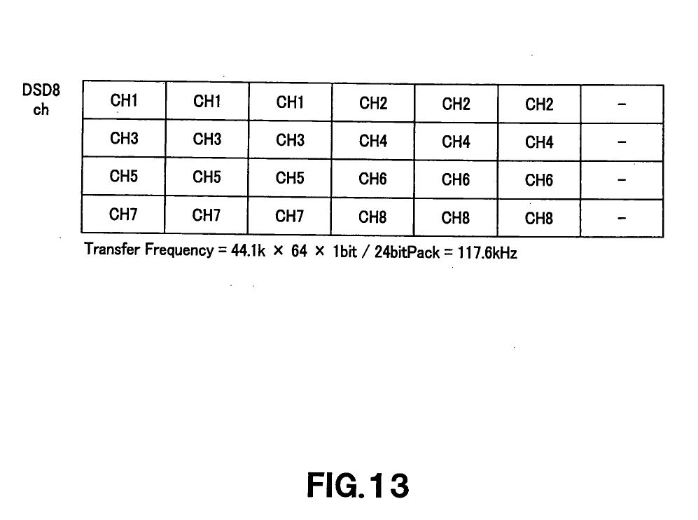

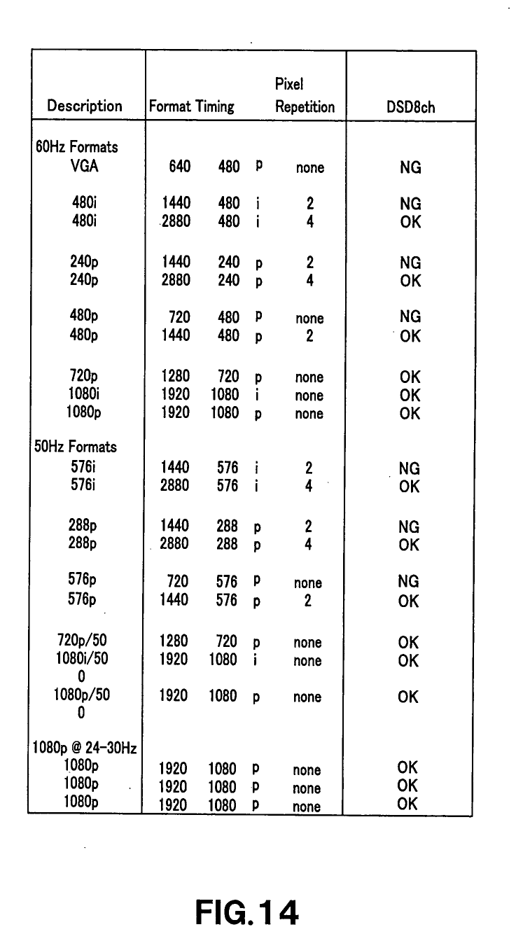

DSD signals with a sampling frequency of 2.8224 MHz (64×44.1 kHz) are used for super audio CDs. DSD 8 ch will be discussed by applying this practice and referring to FIG. 13. Frequency conversion takes place from 2.8224 MHz/24 bitpack to 117.6 kHz. Then, limitations narrower than those defined by the video resolution arise for transmission to give rise to video formats that make multi-channel transmission impossible as shown in FIG. 14. DSD 8 ch transmission is not possible in the video modes of relatively low resolutions including VGA, 480i, 240 p, 480 p of the 60 Hz format and 576i, 288 p, 576 p of the 50 Hz format.

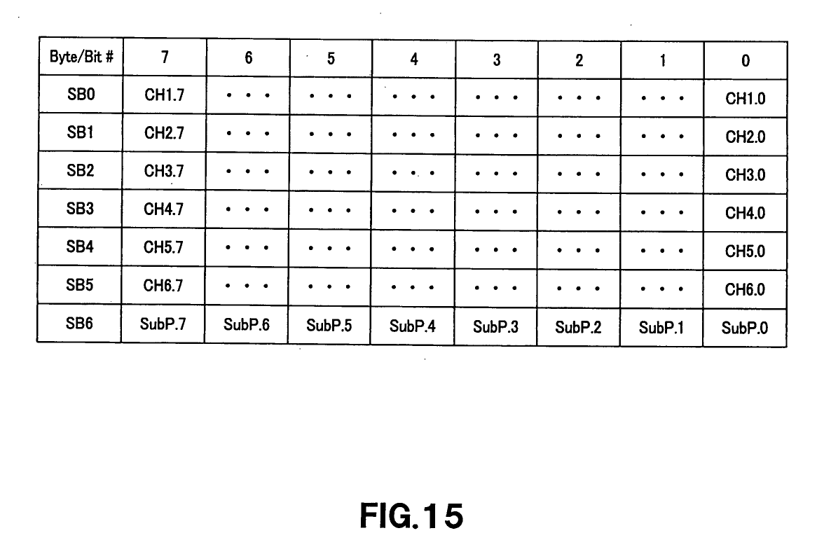

Thus, 1-bit audio data of DSD are defined for a sub-packet format as shown in FIG. 15 by means of a packetizing circuit 32 in the transmission apparatus 3 of this embodiment of video/audio data transmission/reception system 1 according to the invention.

The number of channels is six for super audio CDs, although the largest number of channels is eight for the HDMI in the proper sense of the word. Therefore, the sub-packet format is defined to effectively exploit the transmission band. Referring to FIG. 15, 8-bit data are packetized for each channel of CH1.0˜7, CH2.0˜7, CH3.0˜7, CH4.0˜7, CH5.0˜7 and CH6.0˜7 for six bytes of SB0 through SB5. Additionally, SubP.X (0˜) is assigned to the one byte of SB6. Still additionally, although now shown, CRC is entered to the eighth byte. In short, data of eight bits of each of the six channels are put into a packet. While the concept of word is applied to PCM data, 1-bit data of the DSD system is free form such a concept. The concept of word may correspond to 1-bit data if such a concept has to be used. Thus, the receiving side can decode the data transmitted from the transmitting side simply by arranging the data in the order according to which the data are transmitted.

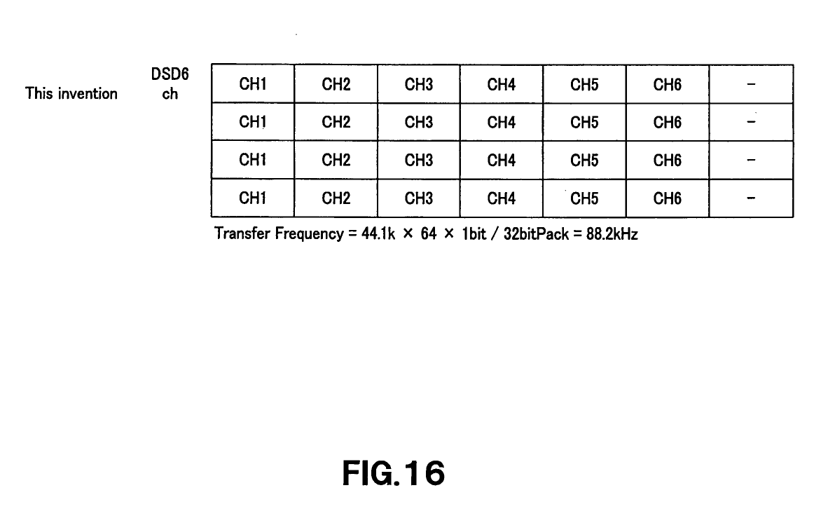

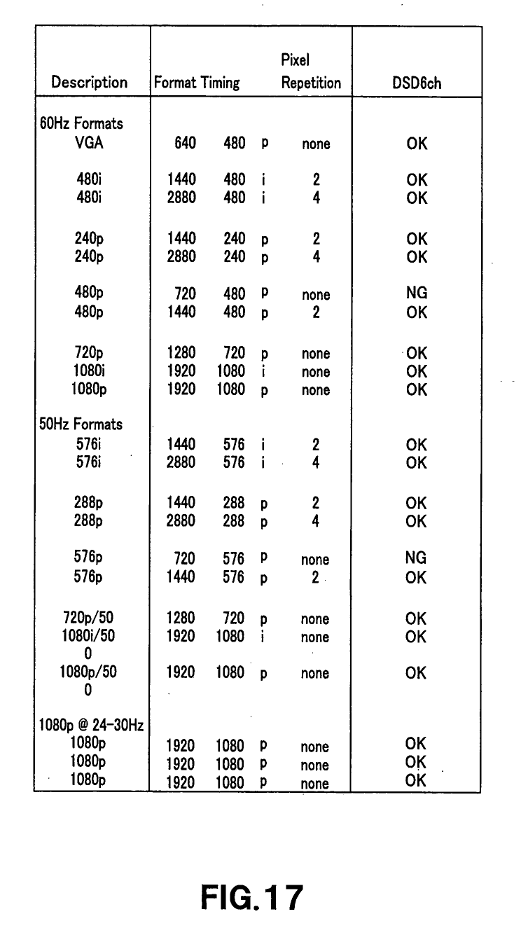

Thus, the packetizing circuit 32 of the transmission apparatus 3 packs every eight bits of DSD data and stacks data for six channels (FIG. 16) in order to form a sub-packet with subordinate information. With this arrangement, it is possible to increase the number of video modes that can be used for multi-channel transmission as shown in FIG. 17. Referring to FIG. 17, there are only two video modes that can not be used for multi-channel transmission. One is the video mode where there is no repetition of 480 p of the 60 Hz format and the other is the video mode where there is no repetition of 576 p of the 50 Hz format. However, monitor/receiving sets that are being popularly used at present are mostly of the repetition type. Additionally, the video modes that are not good for multi-channel transmission can be used for 2-CH transmission. The DSD system employs 1-bit streams and no word is used there unlike PCM. Furthermore, there are neither LSB nor MSB. Thus, it is possible to packetize and transmit any number of bits as audio data. Then, it is possible to reproduce the audio data by connecting them on a time series basis and reconfigure the data stream for reproduction.

The transmission apparatus 3 of the video/audio data transmission/reception system 1 packetizes every eight bits of DSD data and stacks packets of data for six channels by means of the packetizing circuit 32 in order to packetize 1-bit audio data with subordinate information and transmit the packetized data to the multiplexer circuit 33. The multiplexer circuit 33 multiplexes video data and packetized 1-bit audio data according to the frequency-variable clock generated by the variable clock generator circuit 34. As pointed out earlier, the process of multiplexing video data and 1-bit audio data of the multiplexer circuit 33 varies depending on the resolution of the video data to be transmitted or the resolution of the monitor/receiving set 5 of the reception apparatus 4.

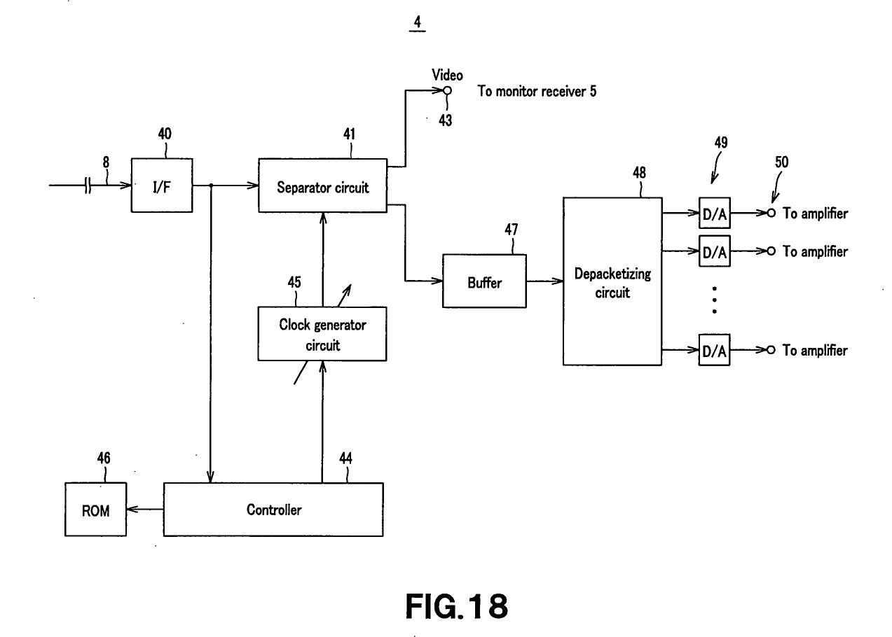

FIG. 18 is a schematic block diagram of the reception apparatus 4, showing its configuration. The reception apparatus 4 is adapted to receive a multiplexed signal of packetized ΔΣ-modulated 1-bit audio data limited for the sampling frequency and the number of channels and video data according to the frequency-variable clock generated by the variable clock generator circuit 34 as a function of the resolution of the video data.

The reception apparatus 4 comprises an I/F circuit 40 that operates as interface of the multiplexed signal from the cable 8 that conforms to the HDMI816B Standard, a separation circuit 41 for separating the video data and the packetized audio data of the multiplexed signal it receives by way of the I/F circuit 40 from each other, a depacketizing circuit 48 for depacketizing the packetized audio data separated by the separation circuit 41 and an audio output section (D/A converter circuit) 49 for outputting the 1-bit audio data depacketized by the depacketizing circuit 48. The reception apparatus 4 additionally comprises a clock generator circuit 45 for generating a frequency-variable clock under the control of controller 44 according to the multiplexed signal received by way of the I/F circuit 40, a controller 44 and a ROM 46 connected to the controller 44. A buffer 47 is arranged between the separation circuit 41 and the depacketizing circuit 48 for temporarily buffering the packetized audio data separated by the separation circuit 41 and transmitting it to the depacketizing circuit 48.

The separation circuit 41 separates the video data and the audio packet data of the multiplexed signal from each other according to the frequency-variable clock generated by the variable clock generator circuit 45. The variable clock generator circuit 45 generates a clock for the reception apparatus according to the variable clock transmitted from the transmission side and detected by the controller 44. The separated video data are supplied to the monitor/receiving set 5 by way of output terminal 43. The audio packet data are supplied to the depacketizing circuit 48 by way of the buffer 47. The depacketizing circuit 48 unpacks the audio packet data received from the buffer 47 and converts them into an analog audio signal typically by means of an analog filter 49 provided for six channels. The analog audio signal is then transmitted to an amplifier (not shown) from output terminal 50.

As a result, the reception apparatus 4 can unpack the audio packet data and reconfigure a stream of data for each channel. Then, it can output sounds from the speakers corresponding to the respective channels.

As described above in detail, the video/audio data transmission/reception system 1 of this embodiment can packetized 1-bit audio data of the DSD system for multi-channel applications and multiplex the data with video data for transmission and/or reception/reproduction even when a data transmission/reception system where the transmission clock is variable as a function of the resolution of the video data as in the case using an HDMI is involved.

Thus, the transmission side can multiplex the multi-channel audio data of an SA-CD and the video data of, for example, an album jacket and transmit the multiplexed data. Then, the reception apparatus can receive the multiplexed data by way of the cable, divide the multiplexed data unpack the 1-bit audio packet and restore the analog signal from the 1-bit audio data so as to output it from speakers. If resolution of the monitor/receiving set 5 of the reception apparatus is lower than the resolution of the images stored on the SA-CD, the transmission side down-converts the resolution before it supplies the 1-bit audio data to the multiplexer circuit 33.

While the transmission apparatus 3 of the video/audio data transmission/reception system 1 of this embodiment multiplexes the video data reproduced by the disc replay apparatus 2 and 1-bit audio data of the DSD system in the above description, it can multiplex the video data input form input terminals 61, 62 with the 1-bit audio data in place of the video data reproduced from a recording medium such as a disc. It can also multiplex the video data and the 1-bit audio data that are generated on a real time basis.

The transmission apparatus 3 can also multiplex the packetized 1-bit audio data read out from a disc and a user interface such as a displayed image of a piece of music or an operation button that is not recorded on any disc but generated by the transmission apparatus 3 itself for transmission.

It should be understood by those skilled in the art that various modifications, combinations, sub-combinations and alterations may occur depending on design requirements and other factors insofar as they are within the scope of the appended claims or the equivalents thereof.

1. A transmission apparatus for transmitting audio data and video data to a reception apparatus, the apparatus comprising:
variable clock generating means for generating a clock with a variable frequency as a function of the resolution of the video data;
packetizing means for packetizing ΔΣ-modulated 1-bit audio data limited for the sampling frequency and the number of channels according to the resolution of the video data;
multiplexing means for multiplexing the ΔΣ-modulated 1-bit audio data packetized by the packetizing means and the video data according to the variable clock generated by the variable clock generating means; and
control means for controlling the process of generating the variable clock by the variable clock generating means according to the resolution of the video data, that of packetizing the ΔΣ-modulated 1-bit audio data by the packetizing means and that of multiplexing the packetized 1-bit audio data and the video data by the multiplexing means.

2. The apparatus according to claim 1, wherein the control means causes the variable clock generating means to generate a clock according to the resolution of the video data of the reception apparatus side and controls the multiplexing process by the multiplexing means.

3. The apparatus according to claim 1, wherein the multiplexing means multiplexes the video data down-converted according to the resolution of the video data at the side of the reception apparatus and the packetized 1-bit audio data.

4. The apparatus according to claim 1, wherein the packetizing means forms packets by packing every eight bits of the 1-bit audio data for six channels.

5. A reception apparatus for receiving a multiplexed signal of video data and packetized and ΔΣ-modulated 1-bit audio data limited for the sampling frequency and the number of channels according to the resolution of the video data, the reception apparatus comprising:
separating means for separating the video data and the packetized audio data from the multiplexed signal;
depacketizing means for depacketizing the packetized audio data separated by the separation means; and
audio output means for outputting the 1-bit audio data depacketized by the depacketizing means.

6. A transmission/reception system comprising:
a transmission apparatus for transmitting audio data and video data to a reception apparatus, the apparatus including:
variable clock generating means for generating a clock with a variable frequency as a function of the resolution of the video data;
packetizing means for packetizing ΔΣ-modulated 1-bit audio data limited for the sampling frequency and the number of channels according to the resolution of the video data;
multiplexing means for multiplexing the ΔΣ-modulated 1-bit audio data packetized by the packetizing means and the video data according to the variable clock generated by the variable clock generating means; and
control means for controlling the process of generating the variable clock by the variable clock generating means according to the resolution of the video data, that of packetizing the ΔΣ-modulated 1-bit audio data by the packetizing means and that of multiplexing the packetized 1-bit audio data and the video data by the multiplexing means; and
a reception apparatus including:
separating means for separating the video data and the packetized audio data of the multiplexed signal of the video data and the packetized ΔΣ-modulated 1-bit audio data limited for the sampling frequency and the number of channels according to the resolution of the video data;
depacketizing means for depacketizing the packetized audio data separated by the separating means; and
audio output means for outputting the 1-bit audio data depacketized by the depacketizing means.

7. A transmission apparatus for transmitting audio data and video data to a reception apparatus, the apparatus comprising:
a variable clock generating section generating a clock with a variable frequency as a function of the resolution of the video data;
a packetizing section packetizing ΔΣ-modulated 1-bit audio data limited for the sampling frequency and the number of channels according to the resolution of the video data;
a multiplexing section multiplexing the ΔΣ-modulated 1-bit audio data packetized by the packetizing section and the video data according to the variable clock generated by the variable clock generating section; and
a controller controling the process of generating the variable clock by the variable clock generating section according to the resolution of the video data, that of packetizing the ΔΣ-modulated 1-bit audio data by the packetizing section and that of multiplexing the packetized 1-bit audio data and the video data by the multiplexing section.

8. A reception apparatus for receiving a multiplexed signal of video data and packetized and ΔΣ-modulated 1-bit audio data limited for the sampling frequency and the number of channels according to the resolution of the video data, the reception apparatus comprising:
a separating section separating the video data and the packetized audio data from the multiplexed signal;
a depacketizing section depacketizing the packetized audio data separated by the separating section; and
an audio output section outputting the 1-bit audio data depacketized by the depacketizing section.

9. A transmission/reception system comprising:
a transmission apparatus for transmitting audio data and video data to a reception apparatus, the apparatus including:
a variable clock generating section generating a clock with a variable frequency as a function of the resolution of the video data;
a packetizing section packetizing ΔΣ-modulated 1-bit audio data limited for the sampling frequency and the number of channels according to the resolution of the video data;
a multiplexing section multiplexing the ΔΣ-modulated 1-bit audio data packetized by the packetizing section and the video data according to the variable clock generated by the variable clock generating section; and
a controller controlling the process of generating the variable clock by the variable clock generating section according to the resolution of the video data, that of packetizing the ΔΣ-modulated 1-bit audio data by the packetizing section and that of multiplexing the packetized 1-bit audio data and the video data by the multiplexing section; and
a reception apparatus including:
a separating section separating the video data and the packetized audio data of the multiplexed signal of the video data and the packetized ΔΣ-modulated 1-bit audio data limited for the sampling frequency and the number of channels according to the resolution of the video data;
a depacketizing section depacketizing the packetized audio data separated by the separating section; and
an audio output section outputting the 1-bit audio data depacketized by the depacketizing section.
